(19) United States
(12) Patent Application Publication
(10) Pub. No.: US 2017/0125940 A1
(43) Pub. Date: May 4, 2017

(54) Connectors for Connecting Electronics Embedded in Garments to External Devices

(71) Applicant: Google Inc., Mountain View, CA (US)

(72) Inventors: Mustafa Emre Karagozler, Mountain View, CA (US); Hakim Raja, San Francisco, CA (US); Ivan Poupyrev, Sunnyvale, CA (US); Youenn Colin, San Francisco, CA (US); Jimmy Chion, Oakland, CA (US); James R. Yurchenco, Palo Alto, CA (US)

(73) Assignee: Google Inc., Mountain View, CA (US)

(21) Appl. No.: 15/343,067

(22) Filed: Nov. 3, 2016

Related U.S. Application Data
(60) Provisional application No. 62/250,937, filed on Nov. 4, 2015.

(51) Int. Cl. H01R 13/62; A42B 1/24; A41B 1/08; H01R 13/627; A41D 1/00

(52) U.S. Cl. CPC H01R 13/6205; H01R 13/627; A41D 1/002; A41B 1/08; A42B 1/24

(57) ABSTRACT

This document describes connectors for connecting electronics embedded in garments to external devices. The connector is configured to connect an external device to a garment to enable communication between electronics embedded in the garment and electronic components of the external device. The connector may include a connector plug and a connector receptacle. The connector plug may be implemented at the external device and is configured to connect to the connector receptacle, which may be implemented at the garment. In one or more implementations, the connector plug includes an anisotropic material that is configured to connect to a printed circuit board (PCB) implemented at the connector receptacle.

### RELATED APPLICATIONS

This application claims priority under 35 U.S.C. Section 119(e) to U.S. Provisional Application No. 62/250,937 entitled “Connectors for Connecting Electronics Embedded in Garments to External Devices” and filed Nov. 4, 2015, the disclosure of which is incorporated by reference herein in its entirety.

### BACKGROUND

Electronics embedded in garments are becoming increasingly common, and such electronics often need connectivity to external devices for power and/or data transmission. Conventional connectors do not provides such connectivity, while at the same time providing multi-pin electrical connections and power transmission simultaneously, being washable and cleanable, being easily engaged and disengaged by the user, remaining locked when desired, being forgiving to rotation misalignments, and/or being easily integrated into fabrics.

### SUMMARY

This document describes connectors for connecting electronics embedded in garments to external devices. The connector is configured to connect an external device to a garment to enable communication between electronics embedded in the garment and electronic components of the external device. The connector may include a connector plug and a connector receptacle. The connector plug may be implemented at the external device and is configured to connect to the connector receptacle, which may be implemented at the garment.

The connector plug may utilize a variety of different materials to form an electrical connection with the connector receptacle. In one or more implementations, the connector plug includes an anisotropic material that is configured to connect to a printed circuit board (PCB) implemented at the connector receptacle. For example, the connector plug, implemented at the external device, may include a first printed circuit board coupled to a strip of an anisotropic conducting polymer. The connector receptacle, implemented at the garment, may include a second printed circuit board that includes circular pads. The strip of anisotropic conducting polymer is configured to form a connection with the circular pads of the second printed circuit board to enable a connection between one or more electronic components of the external device and the electronics embedded in the garment.

In another implementation, the connector plug may include compliant polyurethane polymers to provide compliance to metal pads implemented at the connector receptacle to enable an electromagnetic connection. In another implementation, the connector plug and the connector receptacle may each include magnetically coupled coils which can be aligned to provide power and data transmission between the garment and the external device.

This summary is provided to introduce simplified concepts concerning connectors for connecting electronics embedded in garments to external devices, which is further described below in the Detailed Description. This summary is not intended to identify essential features of the claimed subject matter, nor is it intended for use in determining the scope of the claimed subject matter.

### BRIEF DESCRIPTION OF THE DRAWINGS

Embodiments of connectors for connecting electronics embedded in garments to external devices are described with reference to the following drawings. The same numbers are used throughout the drawings to reference like features and components:

FIG. 1 is an illustration of an example environment in which a connector for connecting electronics embedded in garments to external devices can be implemented.

FIG. 2 illustrates an example of a garment connector when implemented with an anisotropic conducting polymer in accordance with one or more implementations.

FIG. 3 illustrates an exploded view of a garment connector when implemented with an anisotropic conducting polymer in accordance with one or more implementations.

FIG. 4 illustrates various components of an example computing system that can be implemented as any type of client, server, and/or computing device as described with reference to the previous FIGS. 1-3 to implement connectors for connecting electronics embedded in garments to external devices.

### DETAILED DESCRIPTION

### Overview

Electronics embedded in garments are becoming increasingly common. Such electronics often need connectivity to external devices for power and/or data transmission. For example, it can be difficult to integrate bulky electronic components (e.g., such as batteries, microprocessors, wireless units, and sensors) into wearable garments, such as a shirt, coat, or pair of pants. Furthermore, connecting such electronic components to a garment may cause issues with durability since garments are often washed. Thus, instead of integrating such electronic components within the garment, at least some of the electronic components may be placed in an external device. When electronic components are placed in an external device, a connector may be utilized to connect the electronic components in the external device to the electronics embedded in the garment.

Connectors for connecting electronics embedded in garments to external devices are described. The connector is configured to connect an external device to a garment to enable communication between electronics embedded in the garment and the external device. The connector may include a connector plug and a connector receptacle. The connector plug may be implemented at the external device and is configured to connect to the connector receptacle, which may be implemented at the garment. In some cases, these roles may be reversed, such that the connector plug is implemented at the garment and the connector receptacle is implemented at the external device.

The connector plug may utilize a variety of different materials to form an electrical connection with the connector receptacle. In one or more implementations, the connector plug includes an anisotropic material that is configured to connect to a printed circuit board (PCB) implemented at the connector receptacle. For example, the connector plug, implemented at the external device, may include a first printed circuit board coupled to a strip of an anisotropic conducting polymer. The connector receptacle, implemented at the garment, may include a second printed circuit board that includes circular pads. The strip of anisotropic conducting polymer is configured to form a connection with the circular pads of the second printed circuit board to enable a connection between one or more electronic components of the external device and the electronics embedded in the garment.

In another implementation, the connector plug may include compliant polyurethane polymers to provide compliance to metal pads implemented at the connector receptacle to enable an electromagnetic connection. In another implementation, the connector plug and the connector receptacle may each include magnetically coupled coils which can be aligned to provide power and data transmission.

Unlike conventional connectors, the garment connectors described herein are easily integrated into fabrics, provide connectivity between the garment and the external device, provide multi-pin electrical connections and power transmission simultaneously, are washable and cleanable, are easily engaged and disengaged by the user, remain locked when desired, and are forgiving to rotation misalignments which often occur when wearing garments.

### EXAMPLE ENVIRONMENT

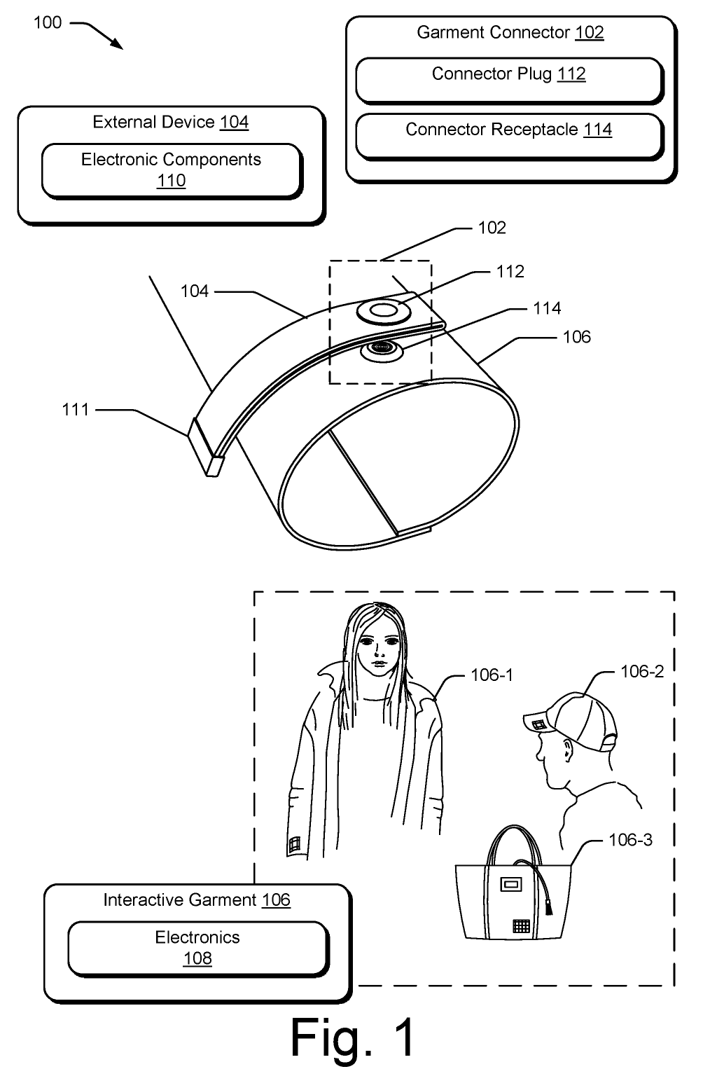

FIG. 1 is an illustration of an example environment 100 in which a connector for connecting electronics embedded in garments to external devices can be implemented. Environment 100 includes a garment connector 102 (“connector 102”) that is configured to connect an external device 104 to an interactive garment 106 (“garment 106”). Doing so enables communication (e.g., data transfer and power transfer) between electronics 108 embedded in garment 106 and external device 104.

Garment 106 may include various types of electronics 108, such as by way of example and not limitation, sensors (e.g., capacitive touch sensors woven or otherwise integrated into the garment, microphones, or accelerometers), output devices (e.g., LEDs, speakers, or micro-displays), electrical circuitry, and so forth. In environment 100, examples of garment 106 include a shirt 106-1, a hat 106-2, and a handbag 106-3. It is to be noted, however, that connector 102 can be configured to connect to any type of garment or flexible object made from fabric or a similar flexible material, such as articles of clothing, blankets, shower curtains, towels, sheets, bed spreads, or fabric casings of furniture, to name just a few.

External device 104 includes various electronic components 110 that are configured to connect and/or interface with electronics 108 of garment 106. Examples of electronic components 110 include batteries, microprocessors, wireless units (e.g., Bluetooth or WiFi), sensors (e.g., accelerometers, heart rate monitors, or pedometers), output devices (e.g., speakers, LEDs), and so forth.

In this example, external device 104 is implemented as a strap that contains the various electronic components 110. The strap, for example, can be formed from a material such as rubber, nylon, or any other type of fabric. Notably, however, external device 104 may take any type of form. For example, rather than being a strap, external device 104 could resemble a circular or square piece of material (e.g., rubber or nylon).

In this example, external device 104 further includes a USB plug 111 which may enable external device 104 to be connected to other devices, such as to connect external device 104 to a computer to charge the device or transfer data. However, in other implementations, external device 104 may be implemented without USB plug 111, or with a different type of connector.

Connector 102 includes a connector plug 112 and a connector receptacle 114. In this example, connector plug 112 is positioned on external device 104 and is configured to attach to connector receptacle 114, which is positioned on garment 106, to form an electronic connection between external device 104 and garment 106. For example, in FIG. 1, connector receptacle 114 is positioned on a sleeve of garment 106.

In various implementations, connector plug 112 may resemble a snap or button, and is configured to connect or attach to connector receptacle 114 via a magnetic or mechanical coupling. For example, in some implementations magnets on connector plug 112 and connector receptacle 114 cause a magnetic connection to form between connector plug 112 and connector receptacle 114. Alternately, a mechanical connection between these two components may cause the components to form a mechanical coupling, such as by “snapping” together.

Connector 102 may be implemented in a variety of different ways. In one or more implementations, connector plug 112 includes an anisotropic conducting polymer which is configured to connect to circular pads of a printed circuit board (PCB) implemented at connector receptacle 114. In another implementation, connector plug 112 may include compliant polyurethane polymers to provide compliance to metal pads implemented at connector receptacle 114 to enable an electromagnetic connection. In another implementation, connector plug 112 and connector receptacle 114 may each include magnetically coupled coils which can be aligned to provide power and data transmission.

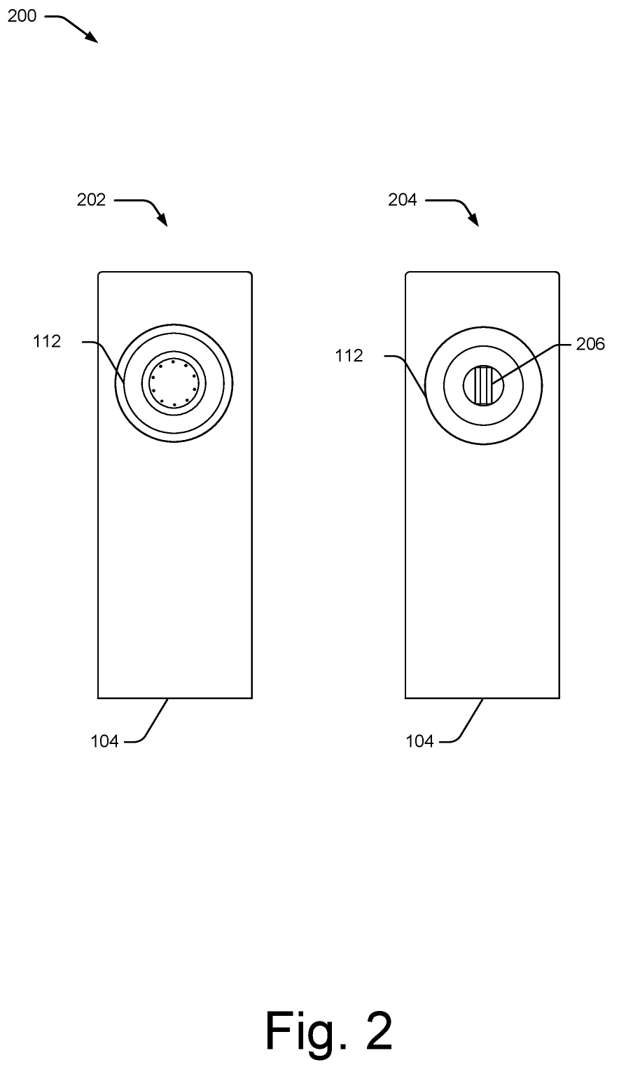

FIG. 2 illustrates an example 200 of garment connector 102 when implemented with an anisotropic conducting polymer in accordance with one or more implementations.

At 202, a top side of connector plug 112 is shown. In this case, the top side of connector plug 112 resembles a round, button-like structure. Notably the top side of connector plug 112 may be implemented with various different shapes (e.g., square or triangular). Further, in some cases the top side of connector plug 112 may resemble something other than a button or snap.

In this example, the top side of connector plug 112 includes one or more openings (e.g., tiny holes) to enable light from one or more light sources (e.g., LEDs) to shine through. Of course, other types of input or output units could also be positioned here, such as a microphone or a speaker.

At 204, a bottom side of connector plug 112 is shown. The bottom side of connector plug 112 includes an anisotropic conducting polymer 206 to enable electrical connections between electronics 108 of interactive garment 106 and electronic components 110 of external device 104.

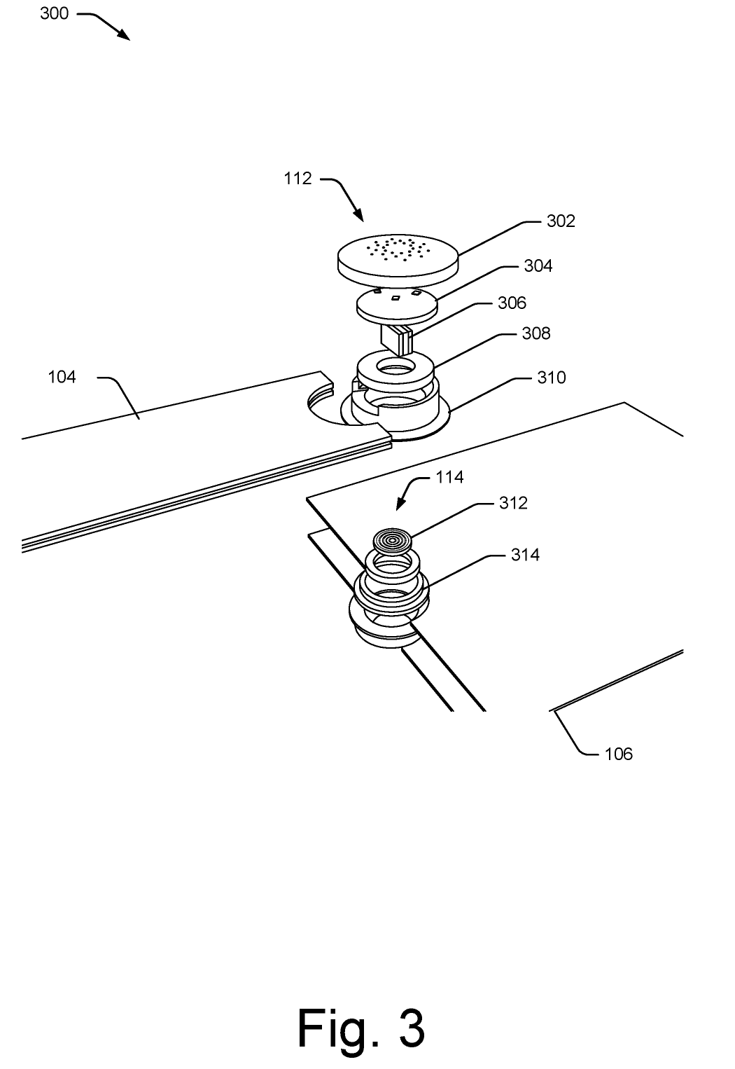

In more detail, consider FIG. 3 which illustrates an exploded view 300 of garment connector 102 when implemented with an anisotropic conducting polymer in accordance with one or more implementations.

In this example, connector plug 112 of connector 102 includes a button cap 302, a printed circuit board (PCB) 304, anisotropic conducting polymer 306, a magnet 308, and a casing 310.

Button cap 302 resembles a typical button, and may be made from a variety of different materials, such as plastic, metal, and so forth. In this example, button cap 302 includes holes which enable light from LEDs to shine through.

PCB 304 is configured to electrically connect electronics 108 of garment 106 to anisotropic conducting polymer 306. A top layer of PCB 304 may include the LEDs that shine through the holes in button cap 302. A bottom layer of PCB 304 includes contacts which electrically connect to anisotropic conducting polymer 306 positioned beneath PCB 304.

Anisotropic conducting polymer 306 includes a strip of anisotropic material that is configured to form a connection with connector receptacle 114. The anisotropic material include any type of anisotropic material.

Magnet 308 is configured to enable a magnetic connection to connector receptacle 114. The magnetic connection enables connector plug 112 to attach to connector receptacle 114 without the need to apply force to connect, which reduces the chance of the connection wearing down over time. Alternately, in one or more implementations, connector plug 112 may be implemented without magnet 308. For example, connector plug 112 could be implemented as physical or mechanical snap that snaps to connector receptacle 114. Casing 310 is configured to hold the components of connector plug 112, and can be implemented from a variety of different materials such as plastic, metal, and so forth.

In this example, connector receptacle 114 includes a receptacle PCB 312 which includes circular pads which are configured to connect to anisotropic conducting polymer 306. The bottom layer of receptacle PCB 312 includes connections to electronics 108 of garment 106.

Connector receptacle may also include a metallic component 314 which is configured to generate a magnetic force with magnet 308 of connector plug 112 to form the magnetic connection between connector plug 112 and connector receptacle 114. Metallic component 314 may be implemented as any type of metal or alloy, or as another magnet, that can generate a magnetic force with magnet 308. Connector receptacle 114 may also include other components, such as a housing, a washer, and so forth.

Notably, anisotropic conducting polymer 306 includes various properties which make for a good connector, which include rotational tolerance, mechanical compliance, multi-pin electrical and power transmission, and being waterproof.

For instance, when connector plug 112 attaches to connector receptacle 114, an electrical connection is formed between anisotropic conducting polymer 306 and receptacle PCB 312. The anisotropic conducting polymer 306 provides rotational tolerance because the strip of anisotropic material can be rotated 360 degrees and maintain the same connection to the circular pads of receptacle PCB 312. This is beneficial because when wearing a garment, the strap of external device 104 will naturally move around. Thus, the rotational tolerance enables the connector to be rotated without losing the connection between connector plug 112 and connector receptacle 114. Furthermore, the anisotropic conducting polymer 306 is elastomeric, which causes the strip of material to shrink and conform under mechanical force.

Anisotropic conducting polymer 306 provides multi-pin electrical transmissions and power transfer transmissions simultaneously. For example, the anisotropic material causes conduction to occur in just one direction, which means that the conductive paths can operate completely independently, without interfering with each other. This enables multiple conducting channels, which makes it easy to isolate multiple data lines or power lines from each other using anisotropic conducting polymer 306 and the circular structure of receptacle PCB 312.

Additionally, anisotropic conducting polymer 306 is waterproof which prevents connector 102 from being damaged by water, such as when being worn in the rain or when being washed.

Connector 102 may be implemented in a variety of different ways. In one or more implementations, instead of using anisotropic conducting polymer 306, connector plug 112 may include compliant polyurethane polymers to provide compliance to metal pads implemented at connector receptacle 114 to enable an electromagnetic connection. In another implementation, connector plug 112 and connector receptacle 114 may each include magnetically coupled coils which can be aligned to provide power and data transmission between garment 106 and external device 104.

### EXAMPLE COMPUTING SYSTEM

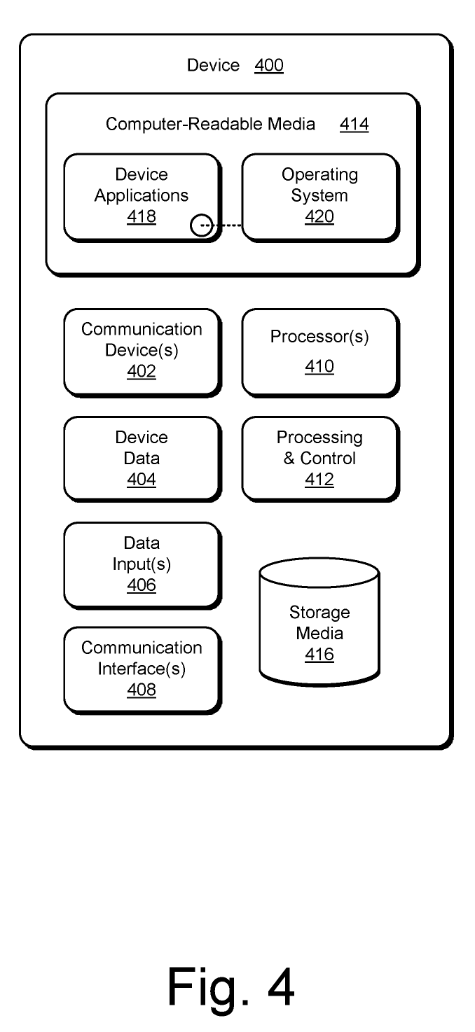

FIG. 4 illustrates various components of an example computing system 400 that can be implemented as any type of client, server, and/or computing device as described with reference to the previous FIGS. 1-3 to implement connectors for connecting electronics embedded in garments to external devices. For example, computing system 400 may correspond to external device 104 and/or embedded in garment 106. In embodiments, computing system 400 can be implemented as one or a combination of a wired and/or wireless wearable device, System-on-Chip (SoC), and/or as another type of device or portion thereof. Computing system 400 may also be associated with a user (e.g., a person) and/or an entity that operates the device such that a device describes logical devices that include users, software, firmware, and/or a combination of devices.

Computing system 400 includes communication devices 402 that enable wired and/or wireless communication of device data 404 (e.g., received data, data that is being received, data scheduled for broadcast, data packets of the data, etc.). Device data 404 or other device content can include configuration settings of the device, media content stored on the device, and/or information associated with a user of the device. Media content stored on computing system 400 can include any type of audio, video, and/or image data. Computing system 400 includes one or more data inputs 406 via which any type of data, media content, and/or inputs can be received, such as human utterances, user-selectable inputs (explicit or implicit), messages, music, television media content, recorded video content, and any other type of audio, video, and/or image data received from any content and/or data source.

Computing system 400 also includes communication interfaces 408, which can be implemented as any one or more of a serial and/or parallel interface, a wireless interface, any type of network interface, a modem, and as any other type of communication interface. Communication interfaces 408 provide a connection and/or communication links between computing system 400 and a communication network by which other electronic, computing, and communication devices communicate data with computing system 400.

Computing system 400 includes one or more processors 410 (e.g., any of microprocessors, controllers, and the like), which process various computer-executable instructions to control the operation of computing system 400 and to enable techniques for, or in which can be embodied, interactive textiles. Alternatively or in addition, computing system 400 can be implemented with any one or combination of hardware, firmware, or fixed logic circuitry that is implemented in connection with processing and control circuits which are generally identified at 412. Although not shown, computing system 400 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Computing system 400 also includes computer-readable media 414, such as one or more memory devices that enable persistent and/or non-transitory data storage (i.e., in contrast to mere signal transmission), examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Computing system 400 can also include a mass storage media device 416.

Computer-readable media 414 provides data storage mechanisms to store device data 404, as well as various device applications 418 and any other types of information and/or data related to operational aspects of computing system 400. For example, an operating system 420 can be maintained as a computer application with computer-readable media 414 and executed on processors 410. Device applications 418 may include a device manager, such as any form of a control application, software application, signal-processing and control module, code that is native to a particular device, a hardware abstraction layer for a particular device, and so on. Device applications 418 also include any system components, engines, or managers to implement connectors for connecting electronics embedded in garments to external devices.

Conclusion

Although embodiments of techniques using, and objects including, connectors for connecting electronics embedded in garments to external devices have been described in language specific to features and/or methods, it is to be understood that the subject of the appended claims is not necessarily limited to the specific features or methods described. Rather, the specific features and methods are disclosed as example implementations of connectors for connecting electronics embedded in garments to external devices.

What is claimed is:

1. A connector for connecting electronics embedded in a garment to an external device, the connector comprising:
a connector plug implemented at the external device, the connector plug comprising a first printed circuit board coupled to a strip of an anisotropic conducting polymer;
a connector receptacle implemented at the garment, the connector receptacle comprising a second printed circuit board comprising circular pads; and
the strip of anisotropic conducting polymer configured to form a connection with the circular pads of the second printed circuit board to enable a connection between one or more electronic components of the external device and the electronics embedded in the garment.

2. The connector of claim 1, wherein the connector plug further comprises a magnet configured to form a magnetic connection with the connector receptacle.

3. The connector of claim 1, wherein the connector plug is configured to form a snap connection with the connector receptacle.

4. The connector of claim 1, wherein the one or more electronic components of the external device comprises one or more sensors, output devices, batteries, or wireless units.

5. The connector of claim 1, wherein the connector plug resembles a snap or a button.

6. The connector of claim 1, wherein the connector plug further comprises one or more light sources, and wherein a top side of the connector plug includes one or more openings to enable light from the one or more light sources to shine through the openings.

7. The connector of claim 1, wherein the strip of anisotropic conducting polymer provides rotational tolerance such that the strip of anisotropic conducting polymer can be rotated 360 degrees while maintaining the connection to the circular pads of the connector receptacle.

8. The connector of claim 1, wherein the anisotropic conducting polymer is waterproof.

9. The connector of claim 1, wherein the anisotropic conducting polymer provides multi-pin electrical transmissions and power transfer transmissions simultaneously.

10. An external device, comprising:
a strap containing one or more electronic components; and
a connector plug configured to connect to a connector receptacle implemented at a garment to enable communication between the electronic components of the external device and electronics embedded in the garment.

11. The device of claim 10, wherein the connector plug further comprises a first printed circuit board coupled to a strip of an anisotropic conducting polymer, the strip of anisotropic conducting polymer configured to form a connection with circular pads of a second printed circuit board implemented at the garment to enable a connection between the one or more electronic components of the external device and the electronics embedded in the garment.

12. The device of claim 10, wherein the connector plug further comprises a magnet configured to form a magnetic connection with the connector receptacle.

13. The device of claim 10, wherein the connector plug is configured to form a snap connection with the connector receptacle.

14. The device of claim 10, wherein the one or more electronic components of the external device comprises one or more sensors, output devices, batteries, or wireless units.

15. A garment, comprising:
one or more electronics embedded within the garment; and
a connector receptacle configured to connect the one or more electronics embedded within the garment to a connector plug implemented at an external device.

16. The garment of claim 15, wherein the connector plug comprises a first printed circuit board coupled to a strip of an anisotropic conducting polymer and the connector receptacle comprises a second printed circuit board comprising circular pads, the circular pads of the second printed circuit board configured to form a connection with the strip of anisotropic conducting polymer to enable a connection between the external device and the electronics embedded in the garment.

17. The garment of claim 15, wherein the connector comprises compliant polyurethane polymers to provide compliance to metal pads implemented at the connector receptacle to enable an electromagnetic connection.

18. The garment of claim 15, wherein the connector plug and the connector receptacle each include magnetically coupled coils which can be aligned to provide power and data transmission between the garment and the external device.

19. The garment of claim 15, wherein the connector receptacle is configured to form a magnetic connection or a snap connection with the connector plug.

20. The garment of claim 15, wherein the one or more electronics embedded within the garment comprises one or more capacitive touch sensors, microphones, accelerometers, light sources, speakers, or micro-displays.
